(19) United States
(12) Patent Application Publication
(10) Pub. No.: US 2026/0235433 A1
(43) Pub. Date: Aug. 13, 2026

(54) DEVICE FOR DETERMINING AND/OR MONITORING AT LEAST ONE PROCESS VARIABLE OF A MEDIUM

(71) Applicant: Endress+Hauser SE+Co. KG, Maulburg (DE)

(72) Inventors: Michael Dötsch, Rickenbach (DE); Laura Mignanelli, Maulburg (DE); Sergey Lopatin, Lörrach (DE); Jan Schleiferböck, Rümmingen (DE); Tobias Brengartner, Emmendingen (DE); Markus Franzke, Schwörstadt-Dossenbach (DE); Peter Wimberger, Schopfheim (DE)

(21) Appl. No.: 19/137,772

(22) PCT Filed: Nov. 28, 2023
(86) PCT No.: PCT/EP2023/083249

§ 371 Date: Jun. 11, 2025

(30) Foreign Application Priority Data
Dec. 16, 2022 (DE) 10 2022 133 730.8

(51) Int. Cl. G01F 23/296; G01K 7/02; G01K 7/16

(52) U.S. Cl. CPC G01F 23/2966; G01K 7/02; G01K 7/16

(57) ABSTRACT

The present disclosure relates to a device for determining and/or monitoring at least one process variable of a medium comprising an electronics unit and a sensor unit having a mechanically oscillatable unit and at least a first tubular piezoelectric element. The device is embodied to excite the mechanically oscillatable unit using a first excitation signal, such that mechanical oscillations are executed in a first oscillation mode, and to receive the mechanical oscillations of the mechanically oscillatable unit in the first oscillation mode and to convert them into an electrical, received signal. The electronics unit is adapted to ascertain the at least one process variable from the received signal. And the mechanical, oscillatable unit includes in an end region at least a first cylindrical bore, in which the at least first piezoelectric element is at least partially inserted.

### The invention relates to a device for determining and/or monitoring at least one process variable of a medium.

Vibronic sensors are widely used in process and/or automation technology. In the case of fill level measuring devices, such have at least one mechanically oscillatable unit, such as, for example, an oscillatory fork, a single tine or a diaphragm. Such is excited during operation by means of an exciting/receiving unit, frequently in the form of an electromechanical transducer unit, such that mechanical oscillations are executed. The exciting/receiving unit can be, in turn, for example, a piezoelectric drive or an electromagnetic drive. Corresponding field devices are manufactured by the applicant in great variety and sold, for example, under the mark LIQUIPHANT or SOLIPHANT. The underpinning measuring principles are known, in principle, from a large number of publications. The exciting/receiving unit excites the mechanically oscillatable unit by means of an electrical excitation signal, such that mechanical oscillations are executed. Conversely, the exciting/receiving unit can receive the mechanical oscillations of the mechanically oscillatable unit and convert them into an electrical, received signal. The exciting/receiving unit is either a separate driving unit and a separate receiving unit, or combined exciting/receiving unit.

In such case, the exciting/receiving unit is in many cases part of a feed back, electrical, oscillatory circuit, by means of which the exciting of the mechanically oscillatable unit occurs, such that mechanical oscillations are executed. For example, conditions for a resonant oscillation of the oscillatory circuit must be fulfilled, according to which the amplification factor is ≥1 and all phases arising in the oscillatory circuit are a multiple of 360°. For exciting and fulfilling the oscillatory circuit conditions, a certain phase shift between the excitation signal and the received signal needs to be assured. Therefore, frequently, a predeterminable value for the phase shift, thus, a desired value for the phase shift between the excitation signal and the received signal, is set. For this, the state of the art provides the most varied of solutions, including both analog as well as also digital methods, such as described, for example, in DE102006034105A1, DE102007013557A1, DE102005015547A1, DE102009026685A1, DE102009028022A1, DE102010030982A1 or DE00102010030982A1.

Both the excitation signal as well as also the received signal are characterized by frequency ω, amplitude A and/or phase φ. Correspondingly, changes in these variables are usually taken into consideration for determining the particular process variable. The process variable can be, for example, a fill level, a predetermined fill level, or the density or viscosity of the medium, as well as the flow. In the case of a vibronic limit level switch for liquids, for example, it is distinguished, whether the oscillatable unit is covered by the liquid or freely oscillating. These two conditions, the free condition and the covered condition, are distinguished, in such case, for example, based on different resonance frequencies, thus, based on a frequency shift.

The exciting/receiving unit is usually embodied as a piezoelectric element in the form of a rectangular disk and is installed in a pocket like hollow space of the oscillatable unit.

Then, the hollow space is filled with a potting compound, such that the exciting/receiving unit is connected by force interlocking, e.g. frictional securement, with a wall of the hollow space. The potting compound is preferably so selected that a very good force coupling between the exciting/receiving unit and the oscillatable unit through the potting compound is obtained. Such an exciting/receiving unit is described, for example, in DE102012100728A1. For producing the hollow space the region of the oscillatable unit provided for the hollow space is, as a rule, eroded by means of a spark erosive material removal method. Such material removal methods are, however, complex and costly.

It is, consequently, an object of the invention, to provide a device, in the case of which the exciting/receiving unit is insertable, in simple manner, into the oscillatable unit.

According to the invention, the object is achieved by a device for determining and/or monitoring at least one process variable of a medium, comprising an electronics unit and a sensor unit having a mechanically oscillatable unit and at least a first tubular piezoelectric element,
wherein the device is embodied to excite the mechanically oscillatable unit by means of a first excitation signal, such that mechanical oscillations are executed in a first oscillation mode, and to receive the mechanical oscillations of the mechanically oscillatable unit in the first oscillation mode and to convert them into an electrical, received signal,
wherein the electronics unit is adapted to ascertain the at least one process variable from the received signal, and
wherein the mechanical, oscillatable unit includes in an end region at least a first cylindrical bore, in which the at least first piezoelectric element is at least partially inserted.

In the device of the invention, the at least first piezoelectric element is inserted in the first cylindrical bore. Such bores are significantly easier to produce than pocket shaped hollow spaces for receiving piezoelectric elements, such as they are known from the above described state of the art. Instead of more complex erosive production methods, simpler and cost effective machining production methods, e.g. drilling, can be utilized.

Additionally, thermomechanical stresses in the region of the at least first tubular piezoelectric element are reduced by using the at least first tubular piezoelectric element. As a rule, the coefficients of thermal expansion of mechanically oscillatable unit, the at least first piezoelectric element and, in given cases, a potting compound, by means of which the at least first piezoelectric element is connected with the at least first cylindrical bore, differ from one another, such that all under influence of temperature stresses occur in the region of the at least first piezoelectric element. Due to the tubular embodiment of the at least first piezoelectric element, it expands especially in the direction of its longitudinal axis. Conventional disks—or platelet shaped piezoelectric elements strain both radially as well as also axially, whereby, greater thermomechanical stresses arise compared with tubular piezoelectric elements. The at least first piezoelectric element is embodied in the form of a tube or tube section.

The mechanically oscillatable unit is, for example, a diaphragm, a single tine, an arrangement of at least two oscillatory elements, or an oscillatory fork. The at least first piezoelectric element can, on the one hand, serve as exciting/receiving unit for producing the mechanical oscillations of the mechanically oscillatable unit produced by means of the excitation signal. The mechanical oscillations, in turn, are influenced by the properties of the medium, when the oscillatable unit is covered by medium, such that, based on the received signal, which represents the oscillations the oscillatable unit, information can be generated concerning the at least one process variable.

In an embodiment, the sensor unit includes at least a second tubular piezoelectric element,
wherein the mechanically oscillatable unit is an oscillatory fork having a first oscillatory element and a second oscillatory element,
wherein the at least first piezoelectric element is inserted, at least partially, in a first cylindrical bore of the first oscillatory element and the at least second piezoelectric element is inserted, at least partially, in a second cylindrical bore of the second oscillatory element.

In an additional embodiment, the device includes a temperature sensor. Temperature influences the mechanical properties of the sensor unit and the most varied of process variables of the medium. By supplemental determining and/or monitoring of temperature, the accuracy of measurement of the device can accordingly be significantly improved and the functionality of the device expanded. Especially, the temperature sensor is a thermocouple or a resistance element.

In a further development, the temperature sensor is located in the at least first cylindrical bore. By locating the temperature sensor in the at least first cylindrical bore together with the at least first piezoelectric element, space is saved and the process temperature optimally evaluated.

In an additional embodiment, the temperature sensor is arranged in a hollow space enclosed by the at least first piezoelectric element. The temperature sensor is located, thus, in the tube, thus tube interior, of the at least first piezoelectric element and is, thus, arranged in especially space saving manner.

An alternative embodiment provides that the temperature sensor is arranged in an end region of the at least first piezoelectric element. Preferably, the temperature sensor is arranged in a mechanically oscillatable unit far end region of the at least first piezoelectric element.

In a further development, the at least first piezoelectric element is electrically connected with the end region of the mechanically oscillatable unit by means of a conductive adhesive or a solder joint.

In an additional embodiment, an outer surface of the at least first piezoelectric element is embodied at least in a first section as a first conductive electrode and an inner surface of the at least first piezoelectric element at least in a second section as a second conductive electrode. The first and second conductive electrodes are, thus, partially or completely formed by the outer and inner surfaces.

In a further development, the at least first piezoelectric element includes an around contact (in that it extends around the piezoelectric element), which is embodied in such a manner that the first conductive electrode is electrically contactable by means of a third section of the inner surface or that the second conductive electrode is electrically contactable by means of a fourth section of the outer surface. The around contact assures that both the first conductive electrode as well as also the second conductive electrode are contactable either on the inner surface or on the outer surface. If the first conductive electrode is formed at least in the first section by the outer surface, then the first section can be drawn in such a manner in the direction of the inner surface that such forms a third section in the region of the inner surface. Alternatively, the second section can be drawn in such a manner in the direction of the outer surface that such forms a fourth section of the outer surface, when the second conductive electrode is formed at least by the second section of the inner surface.

In an additional embodiment, the at least first piezoelectric element is electrically connected with an electrical connecting element by means of the outer surface and/or the inner surface. Especially, the electrical connecting element is a cable or a circuit board. The, in given cases present, temperature sensor can likewise be arranged on the circuit board.

Preferably, the mechanically oscillatable unit is connected by means of its end region with a housing.

Advantageously, the at least first piezoelectric element at least partially contacts a wall of the at least first cylindrical bore.

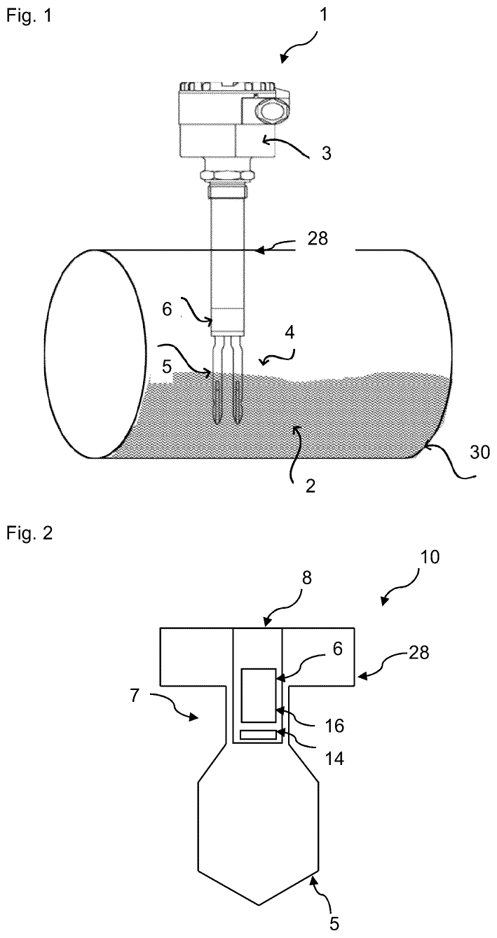

The invention will now be explained in greater detail based on the appended drawing, the FIGS. 1-7 of which show as follows:

FIG. 1 a schematic view of a device of the invention mounted on a containment.

FIG. 2 a schematic view of a first form of embodiment of the sensor unit.

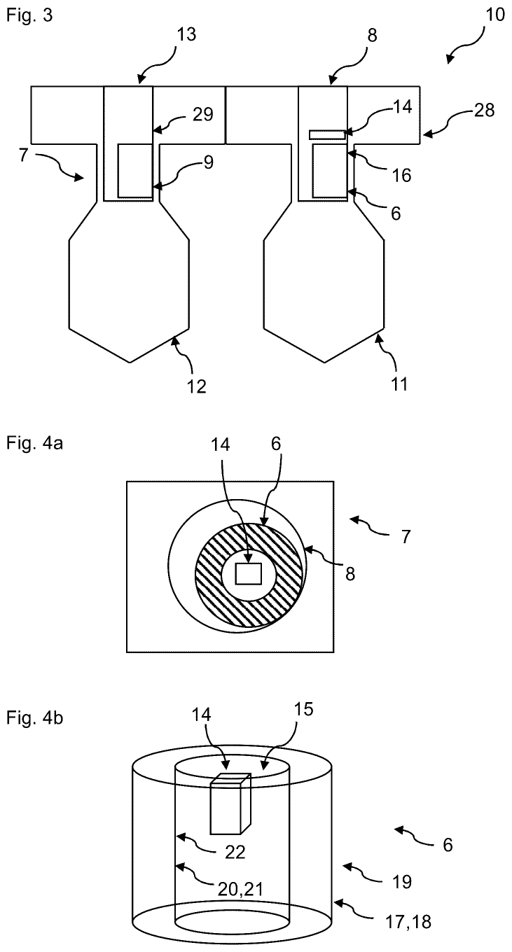

FIG. 3 a schematic view of a second form of embodiment of the sensor unit.

FIG. 4a a sectional view of a third form of embodiment of the sensor unit.

FIG. 4b a schematic view of the third form of embodiment of the sensor unit.

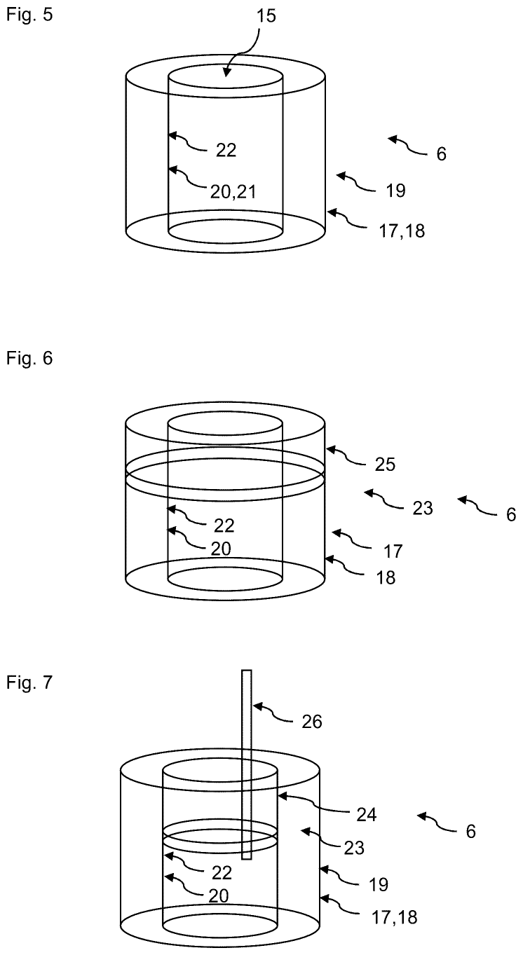

FIG. 5 a detail view of the at least first piezoelectric element.

FIG. 6 a first form of embodiment of the around contact.

FIG. 7 a second form of embodiment of the around contact.

FIG. 1 shows by way of example a device 1 of the invention having an electronics unit 3 and a sensor unit 4. The device 1 is mounted on a container 30, such as, for example, a pipe or a tank. In the container 30 is a medium 2 brought. Sensor unit 4 includes a mechanically oscillatable unit 5 and at least a first piezoelectric element 6 (here hidden by the housing 28 of the device 1). Device 1, especially electronics unit 3, is embodied to excite the mechanically oscillatable unit 5 by means of a first excitation signal, such that mechanical oscillations are executed in a first oscillation mode, and to receive the mechanical oscillations of the mechanically oscillatable unit 5 in the first oscillation mode and to convert them into an electrical, received signal. The electronics unit 3 is, additionally, embodied to ascertain the at least one process variable of the medium 2 from the received signal. The process variable of the medium 2 is, for example, a fill level, a density or a viscosity.

FIG. 2 shows a first form of embodiment of the sensor unit. The mechanically oscillatable unit 5 includes in an end region 7 at least a first cylindrical bore 8, in which the at least first piezoelectric element 6 is at least partially inserted. For example, the at least first piezoelectric element 6 is electrically connected with the end region 7 of the mechanically oscillatable unit 5 by means of a conductive adhesive or a solder joint.

Typically, piezoelectric elements have a coefficient of thermal expansion of, for instance, 6-10-6 K-1. The mechanically oscillatable unit can be made, for example, of stainless steel having a coefficient of thermal expansion of (16-18)·10⁻⁶ K⁻¹. A conventional adhesive as potting compound typically has a coefficient of thermal expansion of (40-60)·10⁻⁶ K⁻¹. Due to the different coefficients of thermal expansion, it thermomechanical stresses arise. By tubular embodiment of the at least first piezoelectric element 6, these are reduced compared with a disk-or platelet shaped embodiment of the at least first piezoelectric element, since in only the axial direction are large areas present, which do not expand in the radial direction.

The mechanically oscillatable unit 5 is optionally connected in its end region 7 with a housing 28. Device 1 can optionally comprise a temperature sensor 14. The temperature sensor 14 can be mounted in the at least a first cylindrical bore 8 and arranged, for example, in an end region 16 of the at least first piezoelectric element 6, such as shown in FIG. 2. Preferably, the temperature sensor 14 is arranged in mechanically oscillatable unit 5 far end region 16 of the at least first piezoelectric element 6, such as shown in FIG. 3.

FIG. 3 shows a second example of an embodiment of the sensor unit 4. In this example, the sensor unit includes 4 an oscillatory fork 10 with a first oscillatory element 11 and a second oscillatory element 12. The first oscillatory element 11 includes the first cylindrical bore 8, in which the at least first piezoelectric element 6 is inserted. The second oscillatory element 12 includes a second cylindrical bore 13, in which an at least second piezoelectric element 9 is inserted. The at least first piezoelectric element 6 and the at least second piezoelectric element 9 are preferably so arranged that each at least partially contacts a wall 29 of its cylindrical bore 8,13. FIG. 3 shows a temperature sensor 14 provided in only the first oscillatory element 11. There can, however, also be a second, redundant, temperature sensor, especially in the second cylindrical bore 13. Alternatively, the temperature sensor 14 can even be arranged in a hollow space 15 enclosed by the at least first piezoelectric element 6, such as shown in FIGS. 4a-b. For this alternative, the temperature sensor 14 needs to be dimensioned in such a manner that, in at least two dimensions, it is less than the inner radius of the at least first piezoelectric element 6.

FIG. 5 shows a detail view of an example of the at least first piezoelectric element 6.

The at least first piezoelectric element 6 includes an outer surface 17 and an inner surface 20. At least one, first section 18 of the outer surface 17 is embodied as a first conductive electrode 19. At least one, second section 21 of the inner surface 20 is embodied as a second conductive electrode 22. In the selected example, the inner surface 20 is embodied completely as a second conductive electrode 22 and the outer surface 17 completely as a first conductive electrode 19.

For simple electrical contacting, the at least first piezoelectric element 6 can have an around contact 23, such as shown in FIGS. 6 and 7. The around contact is so embodied, for example, that the second conductive electrode 22 is electrically contactable by means of a fourth section 25 of the outer surface 17 (compare FIG. 6).

The electrical contacting of the first conductive electrode 19 and the second conductive electrode 20 can occur from the outer surface 17 by means of electrical connection elements 26 (not shown).

Alternatively, the around contact 23 can be so embodied that the first conductive electrode 19 is electrically contactable by means of a third section 24 of the inner surface 20, as shown in FIG. 7. In such case, the first conductive electrode 19 and the second conductive electrode 20 can, in simple manner, be electrically connected with an electrical connecting element 26, for example, a cable or a circuit board. In the case of use of a circuit board as electrical connecting element 26, the temperature sensor 14 can likewise be arranged on such.

### LIST OF REFERENCE CHARACTERS

1 device
2 medium
3 electronics unit
4 sensor unit
5 mechanically oscillatable unit
6 first piezoelectric element
7 end region of mechanically oscillatable unit
8 first cylindrical bore
9 second piezoelectric element
10 oscillatory fork
11 first oscillatory element
12 second oscillatory element
13 second cylindrical bore
14 temperature sensor
15 hollow space
16 end region of the first piezoelectric element
17 outer surface of the first piezoelectric element
18 first section
19 first conductive electrode
20 inner surface of the first piezoelectric element
21 second section
22 second conductive electrode
23 around contact
24 third section
25 fourth section
26 electrical connecting element
28 housing
29 wall of the first cylindrical bore
30 containment

1-14. (canceled)

15. A device for determining and/or monitoring at least one process variable of a medium, comprising:
an electronics unit and a sensor unit having a mechanically oscillatable unit and at least a first tubular piezoelectric element;
wherein the device is embodied to excite the mechanically oscillatable unit by means of a first excitation signal, such that mechanical oscillations are executed in a first oscillation mode, and to receive the mechanical oscillations of the mechanically oscillatable unit in the first oscillation mode and to convert them into an electrical, received signal;
wherein the electronics unit is adapted to ascertain the at least one process variable from the received signal; and
wherein the mechanical, oscillatable unit includes in an end region at least a first cylindrical bore, at which the at least first piezoelectric element is at least partially inserted.

16. The device of claim 15,
wherein the sensor unit includes at least a second tubular piezoelectric element;
wherein the mechanically oscillatable unit is an oscillatory fork having a first oscillatory element and a second oscillatory element;
wherein the at least first piezoelectric element is inserted, at least partially, in a first cylindrical bore of the first oscillatory element and the at least second piezoelectric element is inserted, at least partially, in a second cylindrical bore of the second oscillatory element.

17. The device of claim 15,
wherein the device further comprises a temperature sensor.

18. The device of claim 17,
wherein the temperature sensor is inserted into the at least first cylindrical bore.

19. The device of claim 17,
wherein the temperature sensor is arranged in a hollow space enclosed by the at least first piezoelectric element.

20. The device of claim 17,
wherein the temperature sensor is arranged in an end region of the at least first piezoelectric element.

21. The device of claim 17,
wherein the temperature sensor is a thermocouple or a resistance element.

22. The device of claim 15,
wherein the at least first piezoelectric element is electrically connected with the end region of the mechanically oscillatable unit using a conductive adhesive or a solder joint.

23. The device of claim 15,
wherein an outer surface of the at least first piezoelectric element is embodied at least in a first section as a first conductive electrode and an inner surface of the at least first piezoelectric element is embodied at least in a second section as a second conductive electrode.

24. The device as claimed in claim 23,
wherein the at least first piezoelectric element includes an around contact, which is embodied in such a manner that the first conductive electrode is electrically contactable by means of a third section of the inner surface or that the second conductive electrode is electrically contactable by means of a fourth section of the outer surface.

25. The device as claimed in claim 23,
wherein the at least first piezoelectric element is electrically connected with an electrical connecting element by means of the outer surface and/or the inner surface.

26. The device of claim 25,
wherein the electrical connecting element is a cable or a circuit board.

27. The device of claim 15,
wherein the mechanically oscillatable unit is connected using the end region with a housing.

28. The device of claim 15,
wherein the at least first piezoelectric element at least partially, contacts a wall of the first cylindrical bore.
